(19) United States
(12) Patent Application Publication
(10) Pub. No.: US 2015/0351583 A1
(43) Pub. Date: Dec. 10, 2015

(54) FOOD OR BEVERAGE PRODUCTION SYSTEM

(71) Applicant: NESTEC S.A., Vevey (CH)

(72) Inventors: Karin Weigelt, Chemnitz (DE); Matthias Forster, Dresden (DE); Falk Bosecke, Leipzig (DE)

(21) Appl. No.: 14/654,616

(22) PCT Filed: Dec. 20, 2013
(86) PCT No.: PCT/EP2013/077794

§ 371 Date: Jun. 22, 2015

(30) Foreign Application Priority Data
Dec. 21, 2012 (EP) 12199101.2

(51) Int. Cl. A47J 31/44; A23L 2/39; B67D 1/08; B65D 85/816

(52) U.S. Cl. CPC A47J 31/4492; B65D 85/816; A23L 2/39; B67D 1/0888; B67D 1/0882

(57) ABSTRACT

The invention concerns a system for preparing beverages comprising:—a container enclosing a beverage or food ingredient, wherein the container carries at least one dielectric or conductive pattern said pattern encoding information, and—a dispenser adapted for decoding information encoded by the at least one dielectric or conductive pattern carried by the container and for preparing a food or a beverage from the beverage or food ingredient enclosed in the container.

### FIELD OF THE INVENTION

The present invention relates to beverage dispensers.

### BACKGROUND OF THE INVENTION

It is known to prepare beverages by mixing a beverage concentrate such as a dry powder or a liquid concentrate with a diluent such as cold or hot water. One way to implement the mixing of the concentrate and the diluent is the so-called in-cup mixing where the beverage concentrate is introduced into a drinking cup and then at least a stream or jet of diluent is introduced to the cup in order to enable an interaction of the beverage concentrate and the diluent. Accordingly, the beverage concentrate is dissolved and eventually frothed by the diluent in order to prepare the beverage. Usually the dose of concentrate that is introduced in the empty drinking cup is dosed and dispensed from a storage tank.

The dispenser can comprise several storage tanks holding different types of concentrates—e.g. coffee powder, milk powder, cocoa powder, tea powder—for preparing different types of beverages from each powder or by mixtures of said powders. The dispenser is configured for introducing the jet of diluent in the cup according to specific parameters depending on the nature of the ingredient to be dissolved. These parameters can relate to the volume of diluent introduced in the cup, the velocity of the diluent jet, the movement of the diluent jet during dispensing and influence the effective dissolution of the concentrate and also the texture of the concentrate. For example a high jet velocity enables the incorporation of air in the beverage during its preparation and the creation of foam on the top of the beverage; such a foam is desired for a milky or chocolate beverage but not for a tea. In that last case the diluent shall be introduced with a low velocity in order to create fewer bubbles as possible on the surface of the final beverage. Usually the controller of the dispenser stores information about the process of dissolution in relation to each concentrate and each selected beverage.

Improved beverage dispensers have been developed to get optimised in-cup mixing. In particular dispensers have been defined with:

particular number of diluent jets,
particular orientation or positioning of the diluent jets in the cup,
supply of diluent jets with particular velocities,
movements of the cup or the jets during the supply of diluent.

Usually each beverage dispenser is built to define a specific optimised in-cup mixing corresponding to a particular cup presenting a particular shape (size, bottom surface, walls angle of its walls, . . . ) so that the diluent jets hit the cup walls on always the same cup locations as illustrated for example in WO 2010/034722. If the dispenser is used with another type of cup, then the jet(s) of the device may not correctly mix the food ingredient at the bottom of the cup and the device should be redesigned. Then the problem of beverage dispensers implementing in-cup mixing is that their efficiency is totally dependent from the cups that are used with the dispenser. If the consumer uses a cup that is not designed for fitting with the diluent jets orientation then the mixing is not efficient and the consumer is disappointed. The problem may occur when there is rupture in the supply of cups usually associated with the beverage dispenser and replacement cups are used.

One object of the present invention is to propose a solution to the above problems related to the use of different types of cups with an in-cup mixing beverage dispenser.

It is also known to prepare beverages in the simplest way by introducing hot water in particular drinking cups comprising a pre-packed quantity of a beverage concentrate. Such cups are known as opercule cups. Generally the pre-packed quantity of beverage concentrate is disposed in a compartment closed by removable sealing means so that the concentrate is protected from air and moisture before the cup is used. This kind of opercule cups are described in WO 2008/003570. To prepare the beverage the consumer can introduce hot water from a kettle directly inside the cup. As there can be no control of the process of introduction of the diluent in said cup, the quality of the beverage can only be controlled through the properties of the concentrate packed in the cup; for example, the foamy aspect of cappuccino can only be obtained by the introduction of a foaming agent in the composition of the beverage concentrate.

It has been proposed to use a beverage dispenser to fill such opercule cups with a diluent for the preparation of beverages. Yet the dispenser introduces the diluent in the opercule cup without information about the nature of the concentrate packed in the cup and cannot produce a stream of diluent in the cup fully optimised with the nature of the concentrate to be dissolved.

Another object of the present invention is to propose a solution to the above problem related to the filling of opercule cups with a beverage dispenser.

### SUMMARY OF THE INVENTION

According to a first aspect, the invention concerns a drinking cup, wherein the cup carries at least one dielectric or conductive pattern said pattern encoding information, said dielectric or conductive pattern being positioned under the bottom wall of the cup, the information being encoded by a pattern, said pattern being composed of concentric arcs of circle.

Preferably, the concentric arcs of circle are obtained by the division of a circle in rings of equal width and in angular sectors of equal angle, and the pattern is composed of a selection of at least one of the obtained concentric arcs of circle.

Preferably the information encoded by the pattern relate to features, properties or processing of a beverage or food ingredient enclosed in the drinking cup.

In particular the information encoded by the pattern preferably relate to features or properties of the cup or to features for preparing a beverage or food in said cup.

In the context of the present invention, a dielectric pattern is a pattern defining areas or regions having different dielectric properties, in particular different dielectric coefficients. Similarly, a conductive pattern is a pattern defining areas or regions having different conductive properties, in particular different conductivities. The dielectric coefficient and/or conductivity may vary continuously over the pattern or in discrete steps. The pattern may comprise two distinct coefficients or a plurality of predefined dielectric coefficients/conductivities. Preferably, the first material of the container is made of a material that presents a first dielectric coefficient ε1 and the pattern carried by said container is made of a second material with a second dielectric coefficient ε2, the second coefficient ε2 being different from the first coefficient ε1. Other terms for the dielectric coefficient may include capacitivity, dielectric constant, dielectric permittivity, inductive capacity, permittivity and/or relative permittivity.

According to the preferred embodiment the first material the drinking cup is made of is electrically non-conductive, whereas the second material the pattern is made of is conductive. Yet the embodiment wherein the first material the container is made of is electrically conductive, whereas the second material the pattern is made of is non-conductive can also be implemented.

Examples of electrically conductive materials include, without being limited to, metals, metal particles, materials comprising conductive particles, conductive polymers or any combination of the mentioned materials. Preferably metals (for example aluminum, copper, iron, . . . ), graphite, soot and/or dielectric materials can be considered. Combinations of these materials or even alloys are also possible. Even doped semiconducting material or conductive synthetic materials are conceivable It is preferred that the conductive particles comprise carbon black and/or graphite particles. Beyond these materials salts and electrolytes are also possible as well as liquids, inks and fluids and/or combination of the mentioned materials. It is preferred that liquids, fluids and the like materials get gelled and/or cured, tempered or in any other way stabilized for further processing and/or handling. Stabilizing can also be reached by penetration of the fluids into a soaking surface.

The drinking cup can carry the at least one dielectric or conductive pattern on any surface that can be made accessible to a reader. According to the preferred embodiment the drinking cup carries the at least one dielectric or conductive pattern on its external surface. Yet the pattern can also be positioned on the surface of the cup positioned inside the drinking volume, preferably on the upper part of the cup.

According to a first embodiment the at least one dielectric or conductive pattern can be printed on the drinking cup. The pattern can be printed with a conductive ink.

According to a second embodiment the at least one dielectric or conductive pattern can be applied on the surface of the drinking cup by foil application. For example the dielectric or conductive pattern can be applied according to the process defined in US 2011/0253789 or US 2012/0125993.

According to a second embodiment the at least one dielectric or conductive pattern can be applied by vacuum deposition.

According to a third embodiment the at least one dielectric or conductive pattern can be printed on a label said label being further attached to the drinking cup. As above the pattern can be either printed, foil applied or vacuum deposited on the label itself.

Whatever the embodiment, the pattern can be covered by a laminate.

According to a first mode the drinking cup of the present invention encloses a beverage or food ingredient and preferably said ingredient forms a beverage or a food when it is processed inside the container. Usually the processing consists in mixing the beverage or food ingredient with a diluent inside the drinking cup. Generally the diluent is water. The food or beverage ingredient enclosed in the drinking cup can be a powder or a liquid concentrate. Preferably the beverage concentrate ingredient is selected in the list of instant coffee powder, milk powder, instant tea powder, cocoa powder, soup powder or mixture of said powders. The beverage concentrate can also be a liquid selected in the list of a coffee concentrate, a milk concentrate, a syrup. The food or beverage ingredient is usually disposed in a compartment of the drinking cup closed by removable sealing means. Then the concentrate is protected from air and moisture before the cup is used. According to a particular mode the food or beverage ingredient can be pre-packed in an insert having the shape of second cup, said second cup being smaller than the drinking cup so that this insert can be slid in the drinking cup and positioned at its bottom with its opening turned upwards the opening of the cup. This insert can present any shape or size. Usually its volume does not exceed one third of the internal volume of the drinking cup. The insert can be made of any material. Preferably it is made out of an injection molded thermoplastic material like polystyrene or polyethylene. The insert can be closed by a peelable removable foil made for instance of aluminium. For practical reasons the foil usually presents a tab, said tab being accessible from the top edges of the drinking cup. For such a drinking cup the capacitive pattern can be positioned under the bottom wall of the cup or on the external side wall of the cup although it could also be possible to position the pattern on the edges of the cup or even on the internal walls of the cup. For such a drinking cup the information encoded by the pattern particularly relate to the process of introducing a diluent in the cup.

According to a second mode the drinking cup can be empty. The pattern can encode directly or indirectly information relative to the shape of the cup and the way to prepare a beverage inside the cup.

Whatever the mode or the embodiment the container of the present invention is preferably disposable.

According to a second aspect the invention relates to a food or beverage dispenser adapted for decoding information encoded by the at least one dielectric or conductive pattern carried by the drinking cup such as described hereabove for preparing a food or a beverage in the drinking cup, wherein the dispenser includes a reading device for reading the pattern carried by the drinking cup,

wherein the reading device has at least one input electrode and at least one reading electrode, it being possible for a part of the pattern and the reading unit to be coupled to each other, for the purpose of reading the information, in such a manner that the input electrode and a part of the pattern form a first capacitor and the reading electrode and a part of the pattern form a second capacitor, wherein the reading device has circuit means for generating a digital voltage jump at the input electrode and circuit means for comparing the voltage jump occurring at the reading electrode with a reference voltage, and
wherein the reading device comprises at least one assembly of reading and input electrodes comprising:
at least two consecutive reading electrodes, said reading electrodes presenting the shape of concentric arcs of circle of same angular length, and
at least two input electrodes positioned in the gap between said two consecutive reading electrodes being identical in shape and presenting the shape of arcs of circle, said arcs of circle of the input electrodes being concentric with the arcs of circle of the two consecutive reading electrodes and said several input electrodes lining the both concentric arcs of circle of the two consecutive reading electrodes.

Preferably the angular length of the arcs of circle of the reading electrodes of each assembly is identical. More preferably the reading device comprises four assemblies of reading and input electrodes wherein the angular length of the arcs of circle of the reading electrodes is 90°.

According to the preferred embodiment each assembly of reading and input electrodes comprises four reading electrodes representing three pairs of two consecutive reading electrodes.

Preferably all the input electrodes present the same angular length.

Preferably the dispenser comprises a container receiving area configured for positioning the pattern carried by the container close to the reading device so that each concentric arc of circle of the pattern is put astride in front of an input electrode and in front of a reading electrode.

The food or beverage dispenser generally comprises usual means for preparing a beverage or a food starting from a food or beverage ingredient. In particular for the preparation of a beverage the dispenser generally comprises a water supply, a water pump, a water heater and means for contacting water and the food or beverage ingredient. According to the invention the dispenser preferably includes a reading device for reading the dielectric or conductive pattern carried by the drinking cup. Preferably the reading device presents a surface for facing at least a part of the drinking cup carrying the pattern when the container is positioned for pattern reading in the dispenser. Preferably the dispenser comprises a drinking cup receiving area configured so that the dielectric or conductive pattern carried by the drinking cup is automatically positioned close to the reading device. For example the drinking cup receiving area can present a shape in which the container can exactly fit—for example a drinking cup holder—or the drinking cup receiving area can present indication means for informing the consumer or operator how to place the container in the receiving area.

According to the preferred embodiment the reading device is interconnected with the controller of the dispenser. The controller of the dispenser is usually configured to carry out instructions coded in the pattern to prepare a beverage or a food. The drinking cup can, in connection with the reading device through its pattern, be assigned to or trigger actions of the dispenser.

The information encoded by the pattern or the data extracted from the pattern by the reading device can be simple data which can be used in order to trigger actions in the program run on the dispenser itself.

According to another embodiment the information encoded by the pattern or the data extracted from the pattern by the reading device can be signed information used to perform actions in the program sequence of the dispenser and/or an external data processing system to which the dispenser is connected and which can be connected via a data network to trigger (for example internet).

According to another embodiment the information encoded by the pattern or the data extracted from the pattern by the reading device can be encrypted information which can be decrypted by the program sequence of the dispenser and/or an external data processing system to which the dispenser is connected and that causes actions in the program sequence of the dispenser or in the external data processing system.

According to the present invention the dielectric or conductive pattern, the process for placing said pattern on a container, the device for reading the code such as described in the publications WO 2008/043794, WO 2010/043422, WO 2010/051802 can be implemented.

According to a third aspect the invention concerns a food or beverage production system of a drinking cup and a food or beverage dispenser such as described hereabove.

According to an embodiment the drinking cup can enclose a food or beverage ingredient and the information encoded by the dielectric or conductive pattern carried by the drinking cup can include at least one of the following information:

nature of the food or beverage ingredient,
authenticity of the food or beverage ingredient,
a date of expiration of the food or beverage ingredient enclosed in the drinking cup,
an expiration date determined from the date when the pattern is read by the reading device,
preparation instructions with the beverage dispenser,
information to be displayed on a user interface of the dispenser.

According to another embodiment the dispenser comprises means for introducing a diluent in the drinking cup, and wherein information encoded by the dielectric or conductive pattern carried by the drinking cup includes at least one of the following preparation instructions information:

the temperature of the diluent,
the volume of diluent,
the parameters for introducing the diluent in the cup.

According to this embodiment the dispenser means for introducing the diluent in the drinking cup can comprise:

at least one nozzle delivering a jet of diluent at high pressure, and
at least one nozzle delivering diluent at low pressure,
and the information encoded by the dielectric or conductive pattern carried by the drinking cup includes at least one of the following mixing conditions information:
dispensing time through each nozzle,
flow rate through each nozzle,
sequence of use of each nozzle.

According to this embodiment the dispenser means for introducing the diluent in the drinking cup can comprise several nozzles delivering a jet of diluent at high pressure and means for rotating these nozzles during diluent dispensing, and the information encoded by the dielectric or conductive pattern carried by the drinking cup includes at least one information relative to the rotation speed of the means for rotating the nozzles.

According to this embodiment the information relative to the sequence of use of each nozzle cam comprise:

number of subsequences about the dispensing of diluent through each nozzle,
the time length of each subsequences,
delay between the subsequences.

According to another embodiment the dispenser can comprise support means for supporting the drinking cup and means for relatively moving the support means of the drinking cup to the at least one nozzle, and the information encoded by the dielectric or conductive pattern carried by the drinking cup can include at least one information relative to the relative position of the support to the nozzle during the preparation of the beverage.

According to a fourth aspect the invention concerns the use of a drinking cup such as described hereabove for a system such as described hereabove.

According to a fifth aspect the invention concerns a method of dispensing a food or beverage with a system according such as described hereabove which method comprises the steps of:

placing the drinking cup in or close to the food or beverage dispenser,
decoding information encoded by the dielectric or conductive pattern carried by the drinking cup,
preparing the food or beverage according to the decoded information.

### BRIEF DESCRIPTION OF THE DRAWINGS

The characteristics and advantages of the invention will be better understood in relation to the following figures.

FIG. 1 illustrates a drinking cup carrying a conductive or dielectric pattern on its bottom wall.

FIG. 2 illustrates a pattern that can be carried by a drinking cup according to the present invention.

FIGS. 3A and 3B illustrate drinking cups comprising a pre-packed quantity of beverage concentrate ingredient.

FIG. 4 illustrates a beverage dispenser according to the present invention forming a system with a drinking cup carrying a pattern such as illustrated in FIG. 1.

FIG. 5 illustrates a reading device configured for the beverage dispenser of FIG. 4.

FIG. 6 illustrates a beverage dispenser according to the present invention forming a system with a drinking cup carrying a pattern such as illustrated in FIG. 1.

FIG. 7 illustrates an assembly of sub-nozzles that can be implemented in a dispenser according to FIG. 4 or 6.

FIG. 8 illustrates the general features of a cup with frustoconical shape.

FIG. 9 illustrates one example of sequence used for describing a recipe.

FIG. 10 is a magnified view of a part of the reading device of FIG. 5.

### DETAILED DESCRIPTION OF THE DRAWINGS

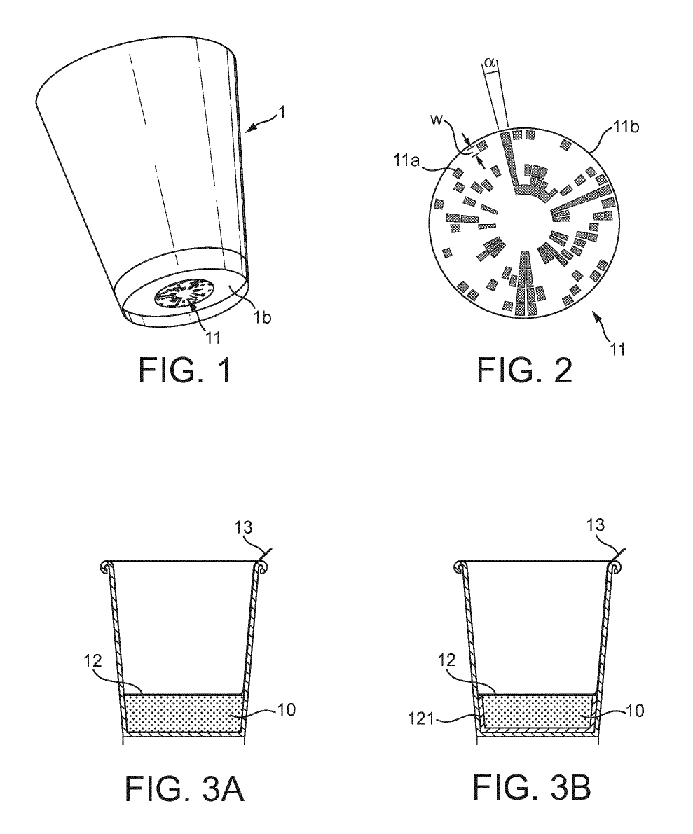

FIG. 1 illustrates an embodiment of a drinking cup 1 and carrying a dielectric or conductive pattern 11. According to this embodiment the drinking cup carries the conductive or dielectric pattern on its bottom side wall 1b. The pattern can be printed on the wall of the cup with an ink presenting a dielectric coefficient different from the dielectric coefficient of the cup material.

FIG. 2 illustrates the pattern placed under the drinking cup. The pattern 11 presents a general circular shape which can fit under the bottom of the cup. The pattern is composed of concentric arcs of circle 11a. The concentric arcs of circle are obtained by the division of the surface of a circle 11b in rings of equal width w and in angular sectors of equal angle α. The pattern is composed of a selection of at least one of said concentric arcs of circle: as illustrated in FIG. 2, the arcs in black are made of a material presenting a dielectric property different from the white parts of the pattern. Consequently the presence or non presence of dielectric or conductive arcs of circle constitutes a specific pattern to which a code is associated.

Preferably the pattern is positioned under the cup so that the arcs are centred on the centre of the cup bottom.

Generally, the pattern can be applied onto the container by additive and/or subtractive methods, preferably by printing or laminating the pattern onto the substrate. In additive methods, the pattern is readily applied onto the container. This may happen in one or more steps of production. Additive methods include, but are not limited to, printing, laminating, transfer and coating methods, for example the methods described in WO 2010/043422. In subtractive methods, the pattern is added onto the container in excess. In one or more following steps, parts of the pattern is removed (e.g. by laser procedures and/or cauterization). For both methods, printing the pattern onto the container is an easy and economic procedure to achieve the desired pattern and thus preferred. Yet, other methods are can be implemented. In particular the attachment of a label presenting the pattern to the drinking cup can be a solution when the dispenser and the cups are not produced by the same manufacturer.

FIG. 3A illustrates a type of drinking cup containing a pre-packed quantity of beverage ingredient that can be used in the present invention. The beverage ingredient is stored at the bottom of the drinking cup and protected from air and humidity by a membrane 12. A part of the edge of the membrane can extend up to the top of the cup and forms a tab 13. The consumer can pull the tab to withdraw the membrane from the cup and then use the cup to prepare a beverage. FIG. 3B illustrate a variant of FIG. 3A in which the beverage ingredient is pre-packed in an insert 121 having the shape of second cup, said second cup being smaller than the drinking cup so that this insert can be slid in the drinking cup and positioned at its bottom with its opening turned upwards the opening of the cup. The insert is closed by the removable membrane 12.

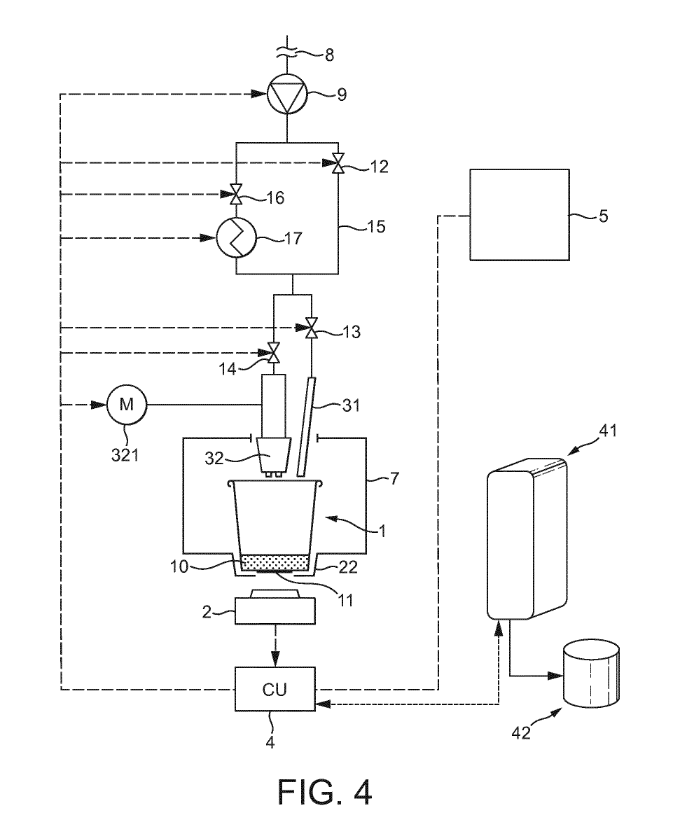

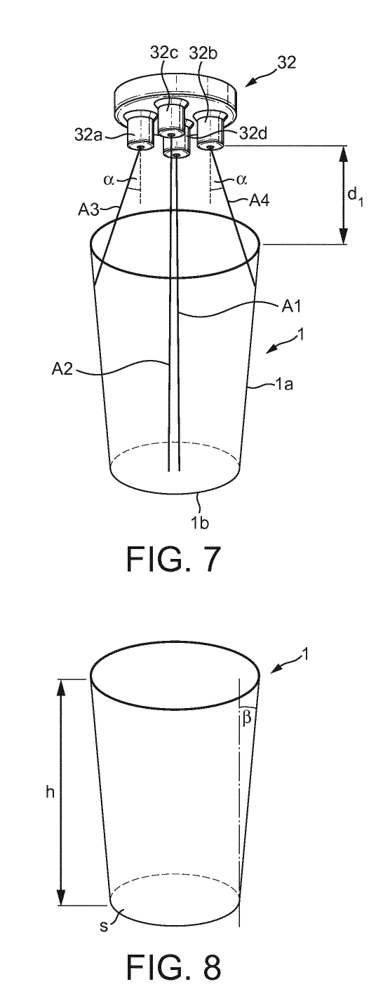

FIG. 4 illustrates a beverage dispenser according to an embodiment of the present invention configured for preparing a beverage with a drinking according to FIG. 2. In FIG. 4 the dispenser comprises a dispensing area 7 configured for receiving a drinking cup 1 enclosing a beverage ingredient 10, preferably as illustrated in FIGS. 3A or 3B, and a conductive or dielectric pattern on its external surface positioned on its bottom as illustrated in FIG. 2. The dispenser presents a receiving area 22 for the drinking cup 1 so that the pattern carried by the cup can be correctly positioned in front of the reading device 2. The dispenser comprises several nozzles for introducing a diluent in the drinking cup 1. FIG. 4 illustrates a dispenser with two different types of nozzles 31 and 32. A first nozzle 31 enables the introduction of a diluent at low pressure. This kind of nozzle enables the rapid and gently filling of a drinking cup; it is useful for producing beverage for which no bubble or foam is desired on the top surface like tea or for completing the filling of a beverage which has been previously foamed. Such a nozzle 31 can present an outlet diameter comprised between 4 and 15 mm, preferably between 8 and 10 mm. The second nozzle 32 is an assembly of several sub-nozzles enabling the introduction of several jets of diluent at high pressure in the cup. FIG. 7 illustrates such an assembly of sub-nozzles and the way these nozzles introduce the diluent in a cup. The assembly comprises four sub-nozzles 32a, 32b, 32c and 32d. Each nozzle is oriented so that it produces a jet of diluent according to a specific orientation and so that the diluent hits the drinking cup at a specific place. For example as illustrated in FIG. 7, two of the sub-nozzles 32a, 32b direct a diluent jet A3, A4 to an inner side wall 1a of the cup and are arranged at different angles (α) with respect to the vertical, and at least two of the sub-nozzles 32c, 32d are designed to direct a diluent jet A1, A2 to the bottom of the cup 1b and are arranged at different angles (β) with respect to the vertical. FIG. 7 illustrates the importance of using always the same shape of cup when a nozzle configuration is set. The jets of diluent are defined to provide specific mixing to get the full dissolution for the beverage ingredient placed in the cup and to provide specific agitation to introduce air in the beverage and get the requested foam. If the shape of the cup (surface of the bottom, angles of the lateral walls, height) changes then the diluent jets do not produce the optimal dissolution and agitation and finally a beverage of quality.

Preferably nozzles 32 providing high velocity jets of diluent present an outlet diameter comprised between 0,5 and 2,5 mm preferably between 0,6 and 1,5 mm. In the embodiment of FIG. 4 the second nozzle 32 can be moved in particularly rotated during the dispensing of diluent in the cup. The movement is produced by a motor 321 to which the second nozzle 32 is connected. The motor 321 can also be used to change the relative distance between the drinking cup placed in the dispensing area and the nozzle 32.

The nozzles 31, 32 are supplied with the diluent that is usually water. The supply of water comprises a source 8 which can be a tank or tap water. A pump 9 drives the water from the source 8. The dispenser comprises a heater 16 to heat the water for the preparation of hot beverages. Alternatively for the production of beverages at ambient temperature the dispenser comprises a by-pass line 15 from the pump outlet to the nozzles. Valves 16, 12 enable the selection of the temperature of the beverage. Two others valves 13, 14 respectively enable the supply of the first nozzle 31 or the second nozzle 32.

The dispensing area 7 enables the positioning of a drinking cup under the at least one nozzle 31, 32 by the consumer. The dispenser comprises a reading device 2 adapted to read the conductive or dielectric pattern 11 on the bottom of the cup 1 once the drinking cup is positioned in the dispensing area. Before positioning the cup 1 in the dispensing area the consumer withdraws the membrane 12.

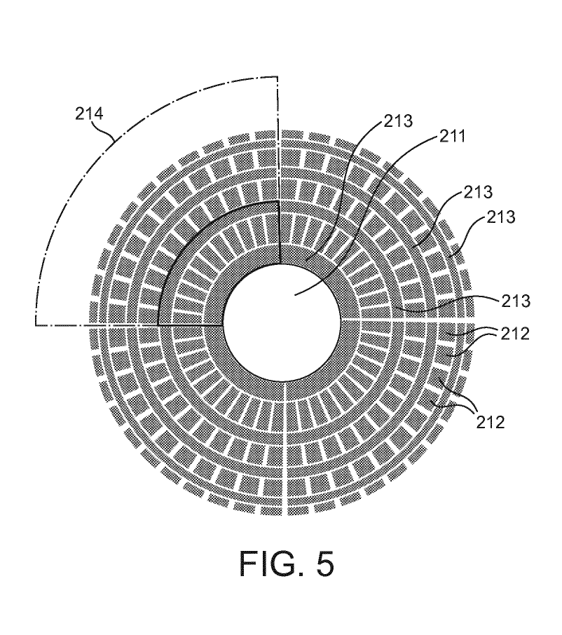

FIG. 5 illustrates the part of the reading device 2 comprising the electrode arrangement designed so that the conductive or dielectric pattern such as illustrated in FIG. 2 can be detected. The reading device 2 comprises a carrier material 211, input electrodes 212 and reading electrodes 213. Once the drinking cup of FIG. 1 is placed in the dispensing area, the conductive or dielectric pattern 11 carried by the cup bottom surface is put nearer the electrodes 212, 213 of the reading device 2.

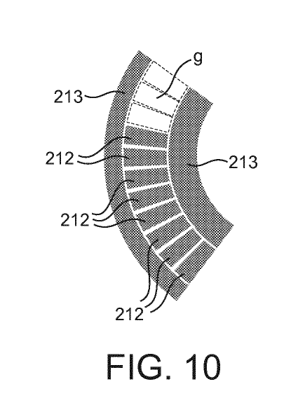

The reading device comprises four assemblies 214 of reading and input electrodes. Each assembly comprises four consecutive reading electrodes 213, said reading electrodes presenting the shape of concentric arcs of circle of same angular length that is 90°. In each assembly, in the gap g between two consecutive reading electrodes 213, eleven input electrodes 212 are positioned as illustrated in FIG. 10. The eleven input electrodes are identical in shape and present the shape of arcs of circle concentric with the arcs of circle of the reading electrodes 213; these eleven input electrodes line the both concentric arcs of circle of the two consecutive reading electrodes in the gap g.

The dispenser receiving area 22 positions the drinking cup 1 so that the pattern 11 carried by the cup and illustrated in FIG. 2 can be correctly positioned in front of the electrodes so that each concentric arc of circle 11a of the pattern is put astride in front of an input electrode 212 and in front of a reading electrode 213.

The pattern and the electrodes arrangement of the present invention enables the coding of numerous information in a dense manner. More information can be coded in a more compacted manner in the cup bottom.

The use of four sub-assemblies can also enable a more rapid reading of the code since there are a lot of reading electrodes. Then simultaneous reading can be implemented in the different zones of the pattern.

As illustrated in FIG. 4 the reading device 2 is connected to the control unit (or controller) 4 of the dispenser so that in function of the conductive or dielectric pattern read by the reading device the control unit 4 adapts the process for introducing water in the drinking cup and for mixing the beverage concentrate ingredient and water. In particular the following devices of the dispenser can be adapted:

the activation of the water pump 9,
the activation of heater 17,
the activation of the hot water valve 16 or the ambient water valve 12,
the activation of the first nozzle valve 14,
the activation of the second nozzle valve 13,
the activation of the second nozzle motor 321.

The activation relates at least to the following aspects:

switching on or off the corresponding device,
the time at which the corresponding device is activated,
the time during which the corresponding device is activated,
the speed of the motors (for pump and for the nozzle rotation).

Depending on the activation or not of these different devices according to specific time sequences, different type of dilution processes can be implemented by the dispenser. The identifier 11 on the drinking cup provides the dispenser with information for implementing the optimal water introduction in the cup to get the optimal beverage from the beverage concentrate ingredient present in the cup and based on the shape of the cup. FIG. 9 illustrates one example of sequence used for describing a recipe. The sequence provides information related to the time of activation of the pump, the time of activation of the rotating jet, the delay between the activation of the different devices. Other information relate to the temperature of the water, the flow of water delivered by the pump, the rotation speed of the second nozzle. In the sequence illustrated in FIG. 5, the recipe comprises 3 sub-sequences:

during the first sub-sequence, diluent is delivered through the second nozzle which is made to rotate, so as to enhance dissolution,
during the second sub-sequence, diluent is delivered through the first nozzle, so as to fill the cup,
during the third sub-sequence, diluent is delivered through the second nozzle which is made to rotate, so as to froth the beverage.

Other recipes can comprise fourth or fifth sub-sequences.

The dispenser also comprises a user interface 5 like a screen on which information related to the beverage under preparation can be presented to the consumer; these information can again be obtained from the information sensed by the reading device 2 through the conductive or dielectric pattern 11.

According to a specific embodiment the control unit 4 of the dispenser can be in communication with an external server 41 and at least one database 42 that can store information about the dispenser or about the drinking cup 1 of which pattern is read by the reading device 2. Based on the information encoded in the conductive or dielectric pattern the control unit 4 can be induced to download information from the external system 41, 42. For example the following information can be downloaded:

information about the beverage concentrate enclosed in the cup, like compositions of the beverage ingredients, origins of the ingredients, nutritional information about the dispensed beverages.
information about the recipes for preparing a beverage from the cup with the particular dispenser of FIG. 4, in particular the process for introducing water in the drinking cup and for mixing the beverage concentrate ingredient and water such as defined in a sequence as illustrated in FIG. 9.

The connection of the dispenser to an external data processing system that causes actions in the dispenser control unit is particularly interesting since the dispenser does not have to be regularly updated with new softwares e.g. each time a new beverage concentrate is developed or a new dilution recipe is implemented.

Based on the information encoded in the conductive or dielectric pattern the control unit 4 can also be induced to upload information in the external system 41, 42. These information can be used to establish consumption patterns.

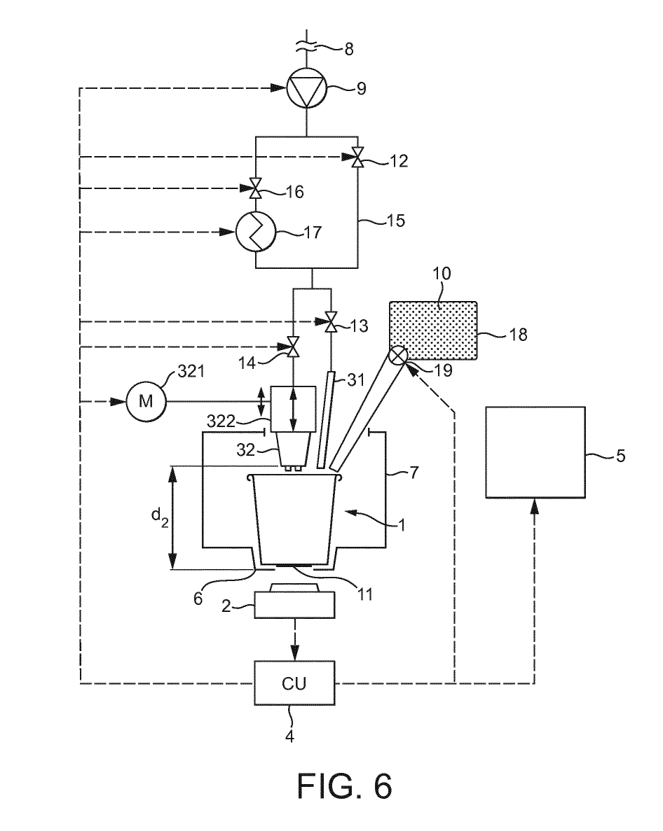

FIG. 6 illustrates a beverage dispenser according to an embodiment of the present invention configured for preparing a beverage inside an empty drinking cup 1. The dispenser comprises a dispensing area 7 and support means 6 configured for receiving the drinking cup 1 of FIG. 1. The dispenser comprises a tank 18 for storing a beverage ingredient 10 and a dosing device 19 for metering a dose of concentrate from the tank and delivering it in the drinking cup.

The dispenser comprises several nozzles for introducing a diluent in the drinking cup 1 in order to dissolve the dose of beverage concentrate delivered in the cup. FIG. 6 illustrates a dispenser with two different types of nozzles 31 and 32. A first nozzle 31 enables the introduction of a free flow of diluent that is at low pressure. This kind of nozzle enables the rapid and gently filling of the drinking cup; it is useful for producing beverage for which no bubble or foam is desired on the top surface like tea or for completing the filling of a beverage which has been previously foamed. Such a nozzle 31 can present an outlet diameter comprised between 4 and 15 mm, preferably between 8 and 10 mm. The second nozzle 32 is an assembly of several sub-nozzles enabling the introduction of several jets of diluent at high pressure in the cup. FIG. 3 illustrates such an assembly of sub-nozzles and the way these nozzles introduce the diluent in a cup. In the embodiment of FIG. 6 the second nozzle 32 can be moved in particularly rotated during the dispensing of diluent in the cup. The movement is produced by a motor 321 to which the second nozzle 32 is connected.

The motor 321 can also be used to change the relative distance between the drinking cup placed in the dispensing area and the nozzle 32.

The nozzles 31, 32 are supplied with the diluent that is usually water. The supply of water comprises a source 8 which can be a tank or tap water. A pump 9 drives the water from the source 8. The dispenser comprises a heater 16 to heat the water for the preparation of hot beverages. Alternatively for the production of beverages at ambient temperature the dispenser comprises a by-pass line 15 from the pump outlet to the nozzles. Valves 16, 12 enable the selection of the temperature of the beverage. Two others valves 13, 14 respectively enable the supply of the first nozzle 31 or the second nozzle 32. The dispenser comprises means 322 for vertically moving the second nozzle 32 and adapting the relative distance d2 between said nozzle and the support means 6 of the drinking cup. Consequently the second nozzle 32 can be vertically positioned to optimally introduce the jets of diluent in the drinking cup.

The dispenser comprises a reading device 2 adapted to obtain information about the shape of the drinking cup 1. This reading device is the same as in FIG. 5. The information encoded by the pattern on the cup can relate at least to the shape of the cup and preferably for a frustoconical shape to at least one of the following information:

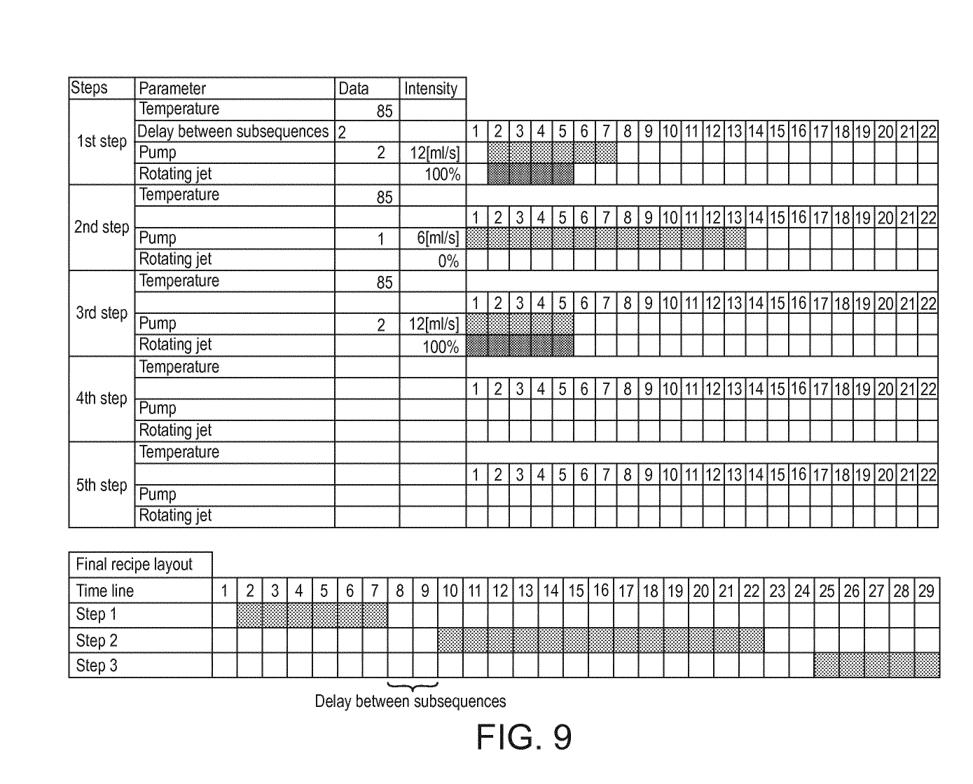

the size S of the area of the cup bottom,
the height h of the cup,
the angle β of lateral walls with vertical, such as illustrated in FIG. 8.

The reading device 2 is connected to the controller 4 of the dispenser so that in function of the information obtained by the sensing device 2 the controller 4 adapts the relative distance d2 between the support 6 and the at least one nozzle 31 in particular by activating the motor 321 of the means 322 for vertically moving the second nozzle 32. For example if the cup presents a height h smaller than a standard cup then the controller 4 makes the motor 321 move the second nozzle 32 downwards so that the jets A3, A4 such as illustrated in FIG. 7 correctly hits the lateral walls of the cup and not out of the cup. The controller 4 can also control other aspects of the beverage preparation based on the information obtained by the sensing device about the cup. In particular the volume of beverage prepared in the cup based on the size of the cup can be controlled and consequently the controller 4 can control:

the activation of the water pump 9 to control the volume of dispensed water,
the activation of the dosing device 19 to control the volume of dispensed beverage concentrate.

The activation relates at least to the following aspects:

switching on or off the corresponding device,
the time at which the corresponding device is activated,
the time during which the corresponding device is activated,
the speed of the motors of the pump, and of the device for rotating nozzles.

The information obtained from the pattern 11 on the drinking cup 1 provides the controller with information for implementing the optimal water introduction in the cup to get the optimal beverage from the beverage concentrate ingredient present in the cup and based on the shape of the cup.

The dispenser forms a system with the drinking cup 1 carrying the pattern 11 on its bottom side with the identifier encoding information about the shape of the cup.

The dispenser can also comprise a user interface 5 like a screen on which information related to the beverage under preparation can be presented to the consumer; these information can again be obtained from the information sensed by the sensing device 2 through the conductive or dielectric pattern 11.

1. A drinking cup, wherein the cup carries at least one dielectric or conductive pattern the pattern encoding information, the dielectric or conductive pattern being positioned under the bottom wall of the cup, the information being encoded by a pattern, the pattern being composed of concentric arcs of circle of equal angular length.

2. A drinking cup according to claim 1, wherein the concentric arcs of circle are obtained by the division of a circle in rings of equal width and in angular sectors of equal angle and the pattern is composed of a selection of at least one of the obtained concentric arcs of circle.

3. A drinking cup according to claim 1, wherein the pattern is positioned under the bottom of the cup so that the concentric arcs of circle are centered on the center of the cup bottom.

4. A drinking cup according to claim 1, wherein the information encoded by the pattern relate to features, properties or processing of a beverage or food ingredient enclosed in the drinking cup.

5. A drinking cup according to claim 1, wherein the information encoded by the pattern relate to features or properties of the cup or to features for preparing a beverage or food in said cup.

6. A food or beverage dispenser adapted for decoding information encoded by the at least one dielectric or conductive pattern carried by a drinking cup, the dielectric or conductive pattern being positioned under the bottom wall of the cup, the information being encoded by a pattern, the pattern being composed of concentric arcs of circle of equal angular length for preparing a food or a beverage in the drinking cup:
the dispenser includes a reading device for reading the pattern carried by the drinking cup;
the reading device has at least one input electrode and at least one reading electrode, it being possible for a part of the pattern and the reading unit to be coupled to each other, for the purpose of reading the information, in such a manner that the input electrode and a part of the pattern form a first capacitor and the reading electrode and a part of the pattern form a second capacitor, wherein the reading device has a circuit for generating a digital voltage jump at the input electrode and the circuit for comparing the voltage jump occurring at the reading electrode with a reference voltage; and
the reading device comprises at least one assembly of reading and input electrodes comprising:
at least two consecutive reading electrodes, the reading electrodes presenting the shape of concentric arcs of circle of same angular length; and
at least two input electrodes positioned in the gap between the two consecutive reading electrodes, the at least two input electrodes being identical in shape and presenting the shape of arcs of circle, the arcs of circle of the input electrodes being concentric with the arcs of circle of the two consecutive reading electrodes and the several input electrodes lining the both concentric arcs of circle of the two consecutive reading electrodes.

7. A food or beverage dispenser according to claim 6 wherein the angular length of the arcs of circle of the reading electrodes of each assembly is identical.

8. A food or beverage dispenser according to claim 7 wherein the reading device comprises four assemblies of reading and input electrodes wherein the angular length of the arcs of circle of the reading electrodes is 90°.

9. A food or beverage dispenser according to claims 6 to 8 claim 6 wherein each assembly of reading and input electrodes comprises four reading electrodes representing three pairs of two consecutive reading electrodes.

10. A food or beverage dispenser according to claim 6 wherein all the input electrodes present the same angular length.

11. A food or beverage dispenser according to claim 6 wherein the dispenser comprises a container receiving area configured for positioning the pattern carried by the container close to the reading device so that each concentric arc of circle of the pattern is put astride in front of an input electrode and in front of a reading electrode.

12. A food or beverage dispenser according to claim 6 wherein the reading device is interconnected with the controller of the dispenser.

13. A food or beverage dispenser according to any claim 12 wherein the controller of the dispenser is configured to carry out instructions coded in the pattern to prepare a beverage or a food.

14. (canceled)

15. A system comprising a drinking cup having at least one dielectric or conductive pattern encoding information and a dispenser wherein the dispenser comprises a member for introducing a diluent in the drinking cup, and
wherein the information encoded by the dielectric or conductive pattern carried by the drinking cup includes at least one of the following preparation instructions information:
the temperature of the diluent,
the volume of diluent, and
the parameters for introducing the diluent in the cup, wherein the drinking cup encloses a food or beverage ingredient and the information encoded by the dielectric or conductive pattern carried by the drinking cup includes at least one of the following information:
nature of the food or beverage ingredient,
authenticity of the food or beverage ingredient,
a date of expiration of the food or beverage ingredient enclosed in the drinking cup,
an expiration date determined from the date when the pattern is read by the reading device,
preparation instructions with the beverage dispenser, and
information to be displayed on a user interface of the dispenser.

16. A system according to claim 15 wherein the dispenser comprises a member for introducing a diluent in the drinking cup, and
wherein the information encoded by the dielectric or conductive pattern carried by the drinking cup includes at least one of the following preparation instructions information:
the temperature of the diluent,
the volume of diluent, and
the parameters for introducing the diluent in the cup.

17. A system according to claim 15 wherein:
the dispenser for introducing the diluent in the drinking cup comprises:
at least one nozzle delivering a jet of diluent at high pressure, and
at least one nozzle delivering diluent at low pressure,
and wherein the information encoded by the dielectric or conductive pattern carried by the drinking cup includes at least one of the following mixing conditions information:
dispensing time through each nozzle,
flow rate through each nozzle, and
sequence of use of each nozzle.

18. A system according to claim 15 wherein:
the dispenser for introducing the diluent in the drinking cup comprises several nozzles delivering a jet of diluent at high pressure and means for rotating these nozzles during diluent dispensing, and
the information encoded by the dielectric or conductive pattern carried by the drinking cup includes at least one information relative to the rotation speed of the means for rotating the nozzles.

19. A system according to claim 17 wherein the information relative to the sequence of use of each nozzle comprises:
number of subsequences about the dispensing of diluent through each nozzle,
the time length of each subsequences, and
delay between the subsequences.

20. A system according to claim 15 wherein the dispenser comprises a support for supporting the drinking cup and a member for relatively moving the support of the drinking cup to the at least one nozzle, and wherein the information encoded by the dielectric or conductive pattern carried by the drinking cup includes at least one information relative to the relative position of the support to the nozzle during the preparation of the beverage.

21. (canceled)

22. A method of dispensing a food or beverage with a system comprising a food or beverage dispenser adapted for decoding information encoded by the at least one dielectric or conductive pattern carried by a drinking cup wherein the cup carries at least one dielectric or conductive pattern the pattern encoding information, the dielectric or conductive pattern being positioned under the bottom wall of the cup, the information being encoded by a pattern, the pattern being composed of concentric arcs of circle of equal angular length for preparing a food or a beverage in the drinking cup, the dispenser includes a reading device for reading the pattern carried by the drinking cup, the reading device has at least one input electrode and at least one reading electrode, it being possible for a part of the pattern and the reading unit to be coupled to each other, for the purpose of reading the information, in such a manner that the input electrode and a part of the pattern form a first capacitor and the reading electrode and a part of the pattern form a second capacitor, wherein the reading device has a circuit for generating a digital voltage jump at the input electrode and the circuit for comparing the voltage jump occurring at the reading electrode with a reference voltage, and the reading device comprises at least one assembly of reading and input electrodes comprising at least two consecutive reading electrodes, the reading electrodes presenting the shape of concentric arcs of circle of same angular length; and at least two input electrodes positioned in the gap between the two consecutive reading electrodes, the at least two input electrodes being identical in shape and presenting the shape of arcs of circle, the arcs of circle of the input electrodes being concentric with the arcs of circle of the two consecutive reading electrodes and the several input electrodes lining the both concentric arcs of circle of the two consecutive reading electrodes, comprising the steps of:
placing the drinking cup in or close to the food or beverage dispenser,
decoding information encoded by the dielectric or conductive pattern carried by the drinking cup; and
preparing the food or beverage according to the decoded information.

23. A system according to claim 6 wherein the dispenser comprises a member for introducing a diluent in the drinking cup, and
wherein the information encoded by the dielectric or conductive pattern carried by the drinking cup includes at least one of the following preparation instructions information:
the temperature of the diluent,
the volume of diluent, and
the parameters for introducing the diluent in the cup.

24. A system according to claim 6 wherein:
the dispenser for introducing the diluent in the drinking cup comprises:
at least one nozzle delivering a jet of diluent at high pressure, and
at least one nozzle delivering diluent at low pressure,
and wherein the information encoded by the dielectric or conductive pattern carried by the drinking cup includes at least one of the following mixing conditions information:
dispensing time through each nozzle,
flow rate through each nozzle, and
sequence of use of each nozzle.

25. A system according to claim 6 wherein:
the dispenser for introducing the diluent in the drinking cup comprises several nozzles delivering a jet of diluent at high pressure and means for rotating these nozzles during diluent dispensing, and
the information encoded by the dielectric or conductive pattern carried by the drinking cup includes at least one information relative to the rotation speed of the means for rotating the nozzles.

26. A system according to claim 18 wherein the information relative to the sequence of use of each nozzle comprises:
number of subsequences about the dispensing of diluent through each nozzle,
the time length of each subsequences, and
delay between the subsequences.

27. A system according to claim 6 wherein the dispenser comprises a support for supporting the drinking cup and a member for relatively moving the support of the drinking cup to the at least one nozzle, and wherein the information encoded by the dielectric or conductive pattern carried by the drinking cup includes at least one information relative to the relative position of the support to the nozzle during the preparation of the beverage.
